(19) United States
(12) Patent Application Publication
(10) Pub. No.: US 2024/0112012 A1
(43) Pub. Date: Apr. 4, 2024

(54) SYSTEMS AND METHODS FOR PROVIDING A UNIFIED CAUSAL IMPACT MODEL WITH HYPEREDGE-ENHANCED EMBEDDING FOR NETWORK INTERVENTIONS

(71) Applicant: Verizon Patent and Licensing Inc., Basking Ridge, NJ (US)

(72) Inventors: Said SOULHI, Boston, MA (US); Bryan Christopher LARISH, Westfield, NJ (US)

(73) Assignee: Verizon Patent and Licensing Inc., Basking Rudge, NJ (US)

(21) Appl. No.: 17/937,916

(22) Filed: Oct. 4, 2022

(51) Int. Cl. G06N 3/08

(52) U.S. Cl. CPC G06N 3/08

(57) ABSTRACT

A device may receive network resource model (NRM) data identifying application layer data, user related data, network layer data, and physical layer data associated with a network, and may generate a graphical NRM that is a causal graph representation of the NRM data. The device may merge key performance indicators (KPIs) and network interventions with the graphical NRM, and may generate a hypergraph NRM. The device may determine first embeddings that preserve a structure of the graphical NRM and second embeddings that preserve a structure of the hypergraph NRM, and may train a causal impact model, based on the first embeddings, the second embeddings, a pre-intervention period, and a post-intervention period, to generate learned relationships. The device may retrain the causal impact model based on the learned relationships to generate a trained causal impact model, and may perform one or more actions with the trained causal impact model.

### BACKGROUND

Interpretability is an ability to understand why a machine learning model makes a decision. Complex machine learning models are difficult to interpret, and an ability to convey why a machine learning model makes a certain decision is important for model adoption.

### BRIEF DESCRIPTION OF THE DRAWINGS

FIGS. 1A-1G are diagrams of an example associated with providing a unified causal impact model with hyperedge-enhanced embedding for network interventions.

FIG. 2 is a diagram illustrating an example of training and using a machine learning model.

FIG. 3 is a diagram of an example environments in which systems and/or methods described herein may be implemented.

FIG. 4 is a diagram of example components of one or more devices of FIG. 3.

FIG. 5 is a flowchart of an example process for providing a unified causal impact model with hyperedge-enhanced embedding for network interventions.

### DETAILED DESCRIPTION OF EXAMPLE EMBODIMENTS

The following detailed description of example implementations refers to the accompanying drawings. The same reference numbers in different drawings may identify the same or similar elements.

Explainability is a degree to which a human observer can understand a reason behind a decision (or a prediction) made by machine learning model. “Explain” means to interpret or to present in understandable terms. Current techniques for analyzing network data are about space and time, but not causality. For example, machine learning models and statistical estimation techniques have focused on estimating models from independent and identically distributed observations. However, this assumption is incorrect. In fact, observations are collected on network nodes in a spatial domain and a temporal domain, and are dependent for instances that naturally arise in cellular networks through peer effects between neighboring cells (e.g., inter-cell interference, handovers, and/or the like).

It is impossible with current machine learning models to detect whether two network key performance indicators (KPIs) cause one another, are independent of each other, or that only one KPI is causing another KPI. Machine learning models lack causal explainability, which needs causal relationship modeling, and hence lack an objective way to estimate causal effects of network interventions. Traditional machine learning models applied to networks deal only with feature importance and not interactions, and lack tools to analyze whether a given KPI causes impact on another KPI. “Feature importance” refers to techniques that assign a score to input features based on how useful the features are at predicting a target variable.

Thus, current techniques for analyzing network data consume computing resources (e.g., processing resources, memory resources, communication resources, and/or the like), networking resources, and/or other resources associated with failing to determine a causal impact of a network intervention (e.g., changing a network feature, introducing a new network feature, changing a configuration of a network device, upgrading software for a network device) on network performance (e.g., network KPIs), performing a network intervention without knowing the causal impact of the network intervention, rendering a network device or a portion of a network under-performing or inoperable based on performing the network intervention, and/or the like. For example, a network device may be rendered under-performing or inoperable due to an erroneous configuration change to the network device.

Some implementations described herein provide a causal system that provides a unified causal impact model with hyperedge-enhanced embedding for network interventions. For example, the causal system may receive network resource model (NRM) data identifying application layer data, user related data, network layer data, and physical layer data associated with a network that includes a plurality of user equipment (UEs), a plurality of radio access networks (RANs), and a core network, and may generate a graphical NRM that is a causal graph representation of the NRM data. The causal system may merge KPIs and network interventions with the graphical NRM, and may generate a hypergraph NRM based on the graphical NRM, the KPIs, and the network interventions. The causal system may determine first embeddings that preserve a structure of the graphical NRM and second embeddings that preserve a structure of the hypergraph NRM, and may define a pre-intervention period and a post-intervention period. The causal system may train a causal impact model, based on the first embeddings, the second embeddings, the pre-intervention period, and the post-intervention period, to generate learned relationships, and may retrain the causal impact model based on the learned relationships to generate a trained causal impact model. The causal system may perform one or more actions with the trained causal impact model.

In this way, the causal system provides a unified causal impact model with hyperedge-enhanced embedding for network interventions. For example, the causal system may provide a causal impact model that represents cause-effect connections in networks and that determines an effectiveness of network interventions in an objective and quantitative way. The causal system may utilize the causal impact model and hypergraph neural networks to improve learning representation and explainability of network performance. The causal system may perform knowledge engineering of the network to generate a hypergraph that captures each network node and relationships of the network node with neighboring network nodes. Thus, the causal system may conserve computing resources, networking resources, and/or other resources that would otherwise have been consumed in failing to determine a causal impact of a network intervention on network performance, performing a network intervention without knowing the causal impact of the network intervention, rendering a network device or a portion of a network under-performing or inoperable based on performing the network intervention, and/or the like.

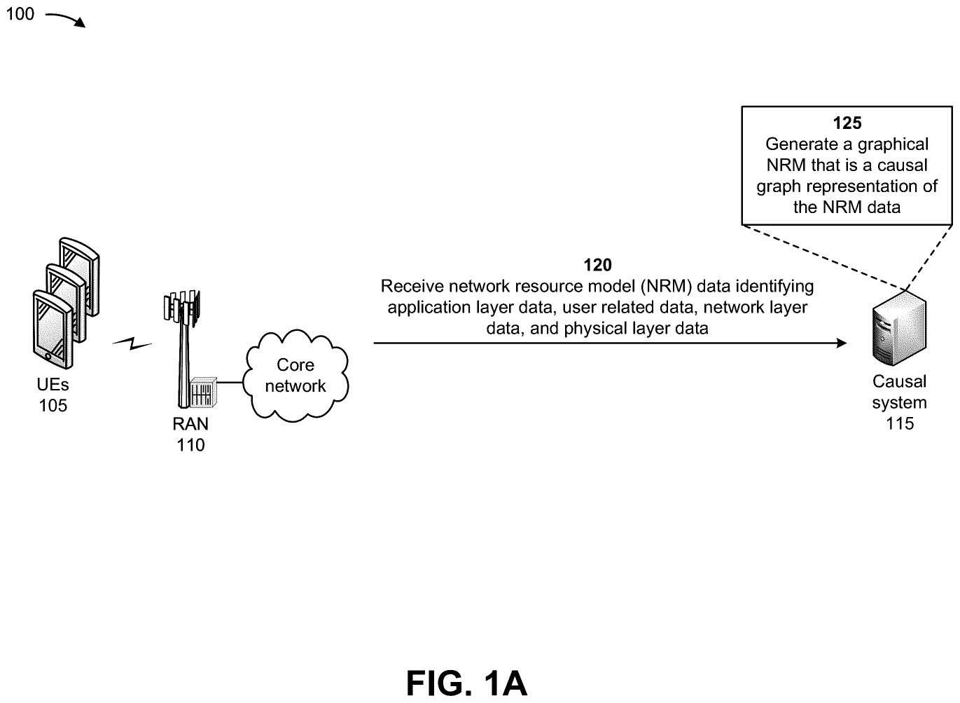

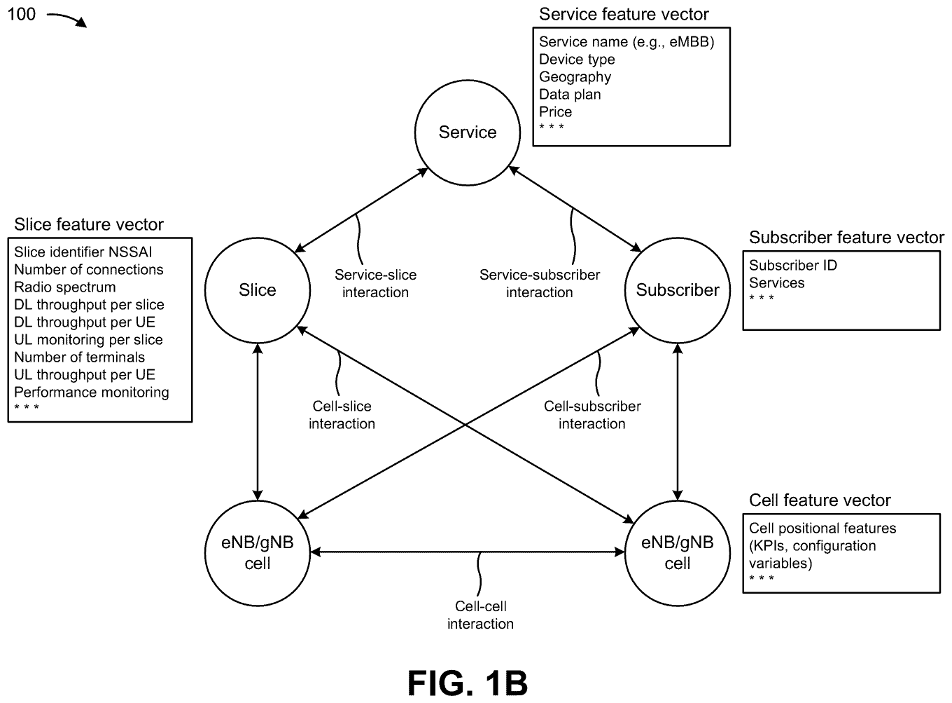

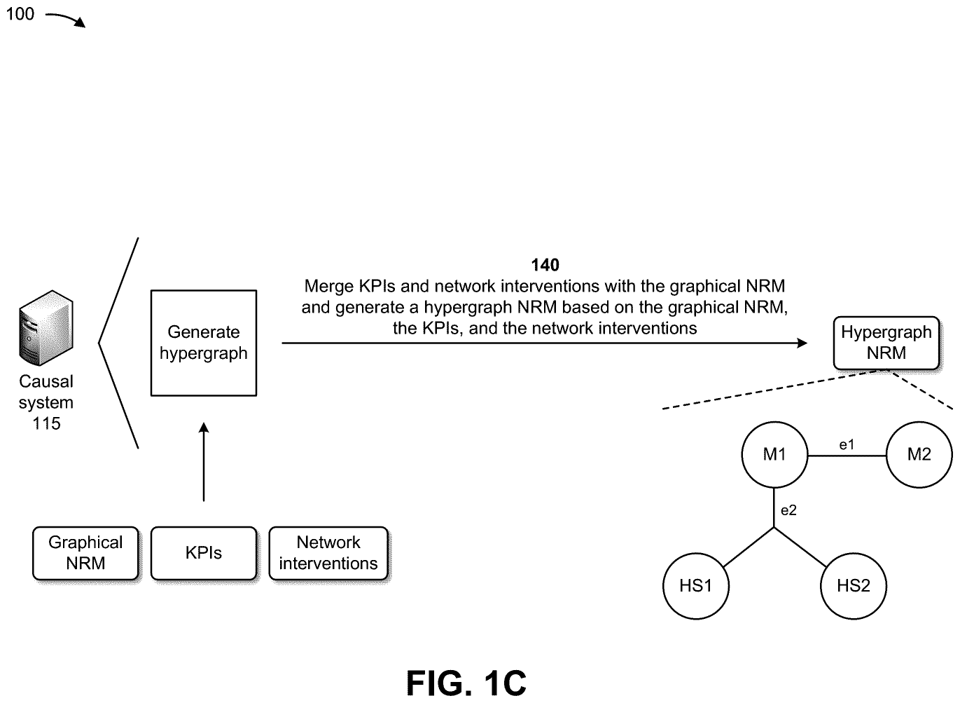

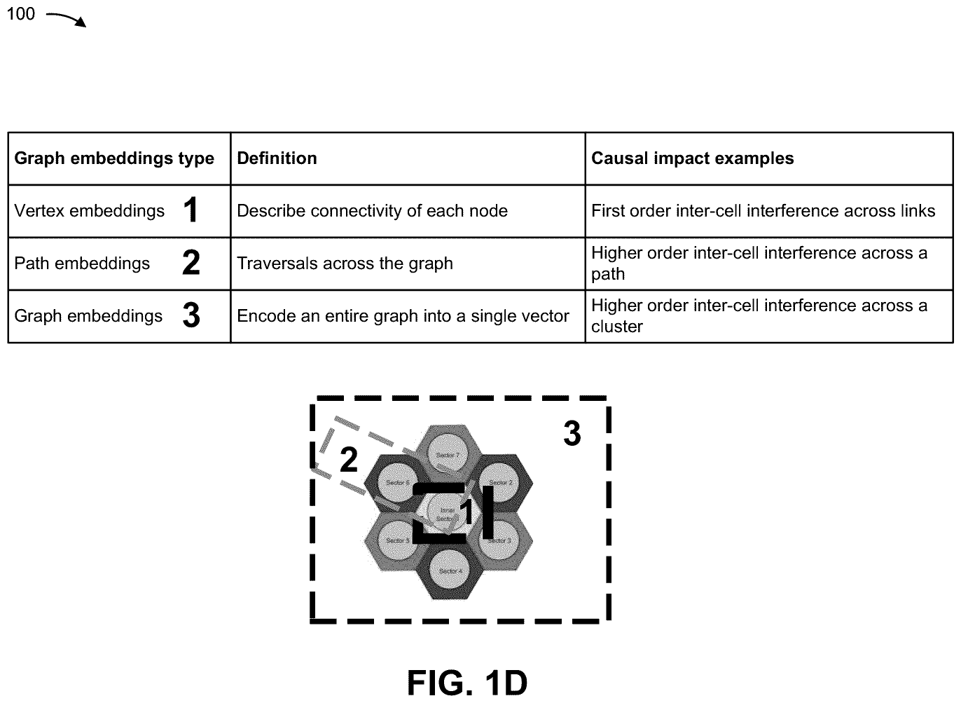

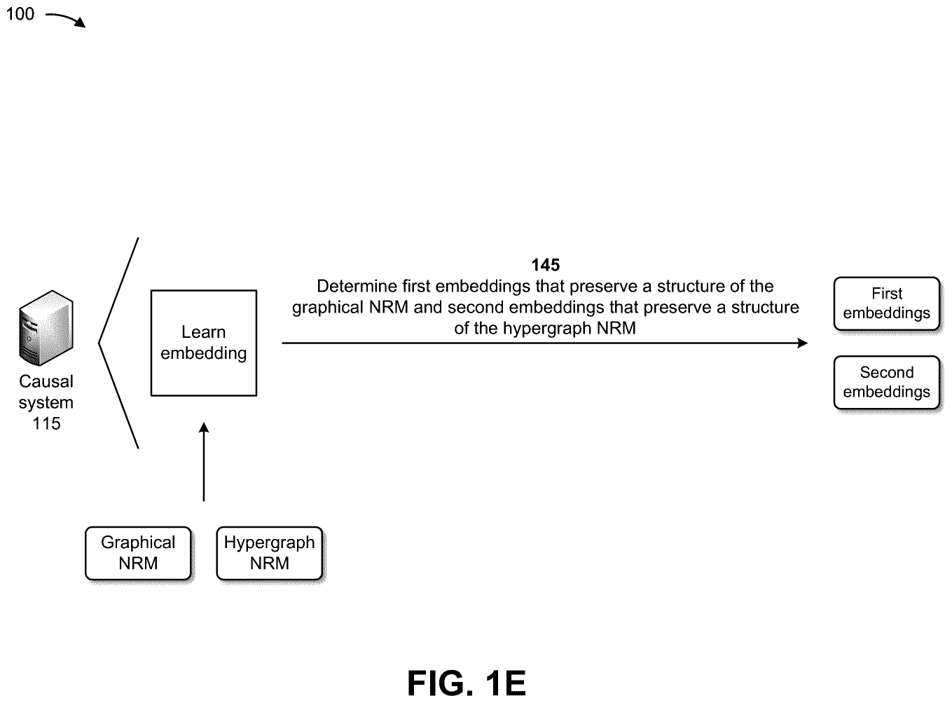

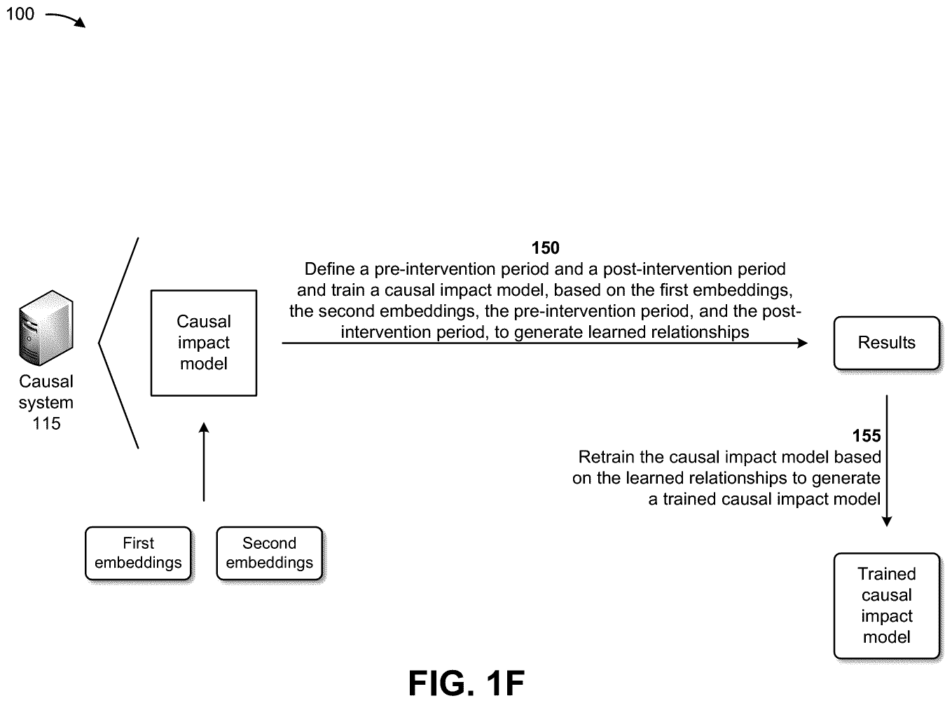

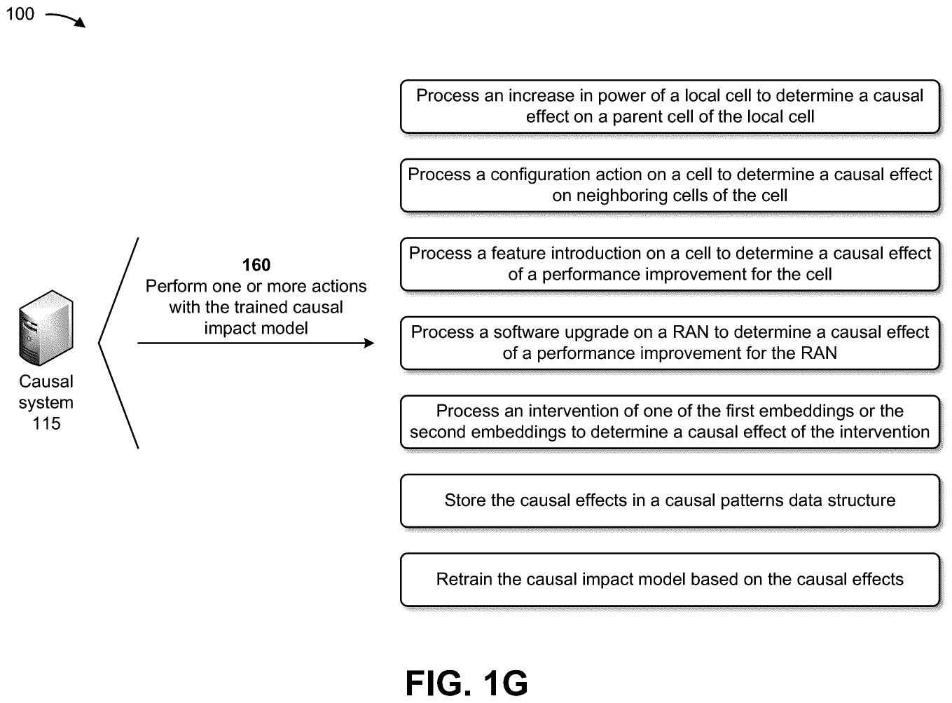

FIGS. 1A-1G are diagrams of an example 100 associated with identifying and correcting issues associated with a wireless network. As shown in FIGS. 1A-1G, example 100 includes a plurality of UEs 105, a radio access network (RAN) 110, a core network, and a causal system 115. Further details of the plurality of UEs 105, the RAN 110, the core network, and the causal system 115 are provided elsewhere herein.

As shown in FIG. 1A, and by reference number 120, the causal system 115 may receive NRM data identifying application layer data, user related data, network layer data, and physical layer data. For example, NRM data allows service providers to control and monitor actual configurations of the network resources that are fundamental resources for mobile networks. The NRM data may include the application layer data, the user related data, the network layer data, and the physical layer data associated with the plurality of UEs 105, the RAN 110, and the core network. The application layer data may include data identifying end-user software (e.g., web browsers, email clients, and/or the like), protocols that allow software to send and receive information and present meaningful data to users (e.g., a hypertext transfer protocol (HTTP), a file transfer protocol (FTP), a post office protocol (POP), a simple mail transfer protocol (SMTP), domain name system (DNS), etc.), a service level, a connection level, device level key quality indicators, quality of experience, and/or the like. The user related data may include data identifying configurations associated with the plurality of UEs 105, applications utilized by the plurality of UEs 105, KPIs associated with the plurality of UEs 105, quality of service (QoS) associated with the plurality of UEs 105, user-level network data that is event-based, session-based, UE-level-based, and device-level-based, trajectories of the UEs 105, behaviors of the UEs 105, and/or the like. The network layer data may include data identifying inter-network connections, routes for data packets to traverse, addressing and receiving packets from other networks, network layer protocols that determine a route that is suitable from a source to a destination, multicast group management, network layer information and error, network layer address assignment, cell-level aggregated network data, aggregated user-level KPIs, and/or the like. The physical layer data may include data identifying electrical, mechanical, and procedural interfaces to transmission media, shapes and properties of electrical connectors, frequencies to broadcast on, line code to use, and similar low-level parameters, measurement reports, channel state information, channel quality indicators, and/or the like.

In some implementations, the causal system 115 may continuously receive the NRM data from the plurality of UEs 105, the RAN 110, and the core network; may periodically receive the NRM data from the plurality of UEs 105, the RAN 110, and the core network; may receive the NRM data from the plurality of UEs 105, the RAN 110, and the core network based on providing requests to the plurality of UEs 105, the RAN 110, and the core network; and/or the like.

As further shown in FIG. 1A, and by reference number 125, the causal system 115 may generate a graphical NRM that is a causal graph representation of the NRM data. For example, underlying relationships among data in networks may be represented in terms of graphs. The causal system 115 may determine a structure of the graphical NRM from the NRM data by utilizing 3GPP integration reference points (IRPs), such as inventory management (IM) NRM IRP, a configuration IRP, and/or the like. Based on the structure of the graphical NRM, the causal system 115 may generate a topology (e.g., nodes and links) for the graphical NRM and may generate services for the graphical NRM. The graphical NRM may include a causal graph representation of the NRM data. In some implementations, when generating the graphical NRM, the causal system 115 may determine a structure of the network based on the NRM data. For example, the causal system 115 may identify the plurality of UEs 105, the RAN 110, the core network, and interrelations between the plurality of UEs 105, the RAN 110, and the core network. The causal system 115 may generate a topology of the network based on the structure of the network. The topology of the network may include data identifying an arrangement of elements (e.g., links, nodes, and/or the like) of the network, placement of various components of the network (e.g., device location and cable installation), data flows within the network, and/or the like. The causal system 115 may generate the services of the network based on the structure of the network, and may generate the graphical NRM based on the topology of the network and the services of the network.

FIG. 1B depicts an example graphical NRM that may be generated by the causal system 115 based on NRM data. As shown, the graphical NRM may include nodes representing a network slice (e.g., of the core network or radio network), a service, a subscriber (e.g., a UE 105), and eNB/gNB cells (e.g., RANs 110). The graphical NRM may include links between the nodes, such as a service-slice interaction link provided between the network slice node and the service node, a service-subscriber interaction link provided between the service node and the subscriber node, cell-slice interaction links provided between the eNB/gNB cell nodes and the network slice node, cell-subscriber interaction links provided between the eNB/gNB cell nodes and the subscriber node, and a cell-cell interaction link provided between the eNB/gNB cell nodes. As further shown in FIG. 1B, the nodes may be associated with feature vectors, such as a slice feature vector (e.g., defining a slice identifier, a number of connections, a radio spectrum, downlink (DL) throughput per slice, DL throughput per UE, uplink (UL) monitoring per slice, a number of terminals, UL throughput per UE, performance monitoring, and/or the like), a service feature vector (e.g., defining a service name, a device type, a geography, a data plan, a price, and/or the like), a subscriber feature vector (e.g., defining a subscriber identifier (ID), services and/or the like), and a cell feature vector (e.g., defining cell positional features, KPIs, configuration variables and/or the like).

As shown in FIG. 1C, and by reference number 140, the causal system 115 may merge KPIs and network interventions with the graphical NRM and generate a hypergraph NRM based on the graphical NRM, the KPIs, and the network interventions. For example, the KPIs may include bandwidths, throughputs, signal strengths, indications of service availability (e.g., percentages of time that the RAN 110 is providing services to the UEs 105), indications of network resources (e.g., traffic and control channels provided by the RAN 110), indications of handovers (e.g., a handover of a moving UE 105 from one RAN 110 to another RAN 110), voice service indicators, data service indicators, and/or the like.

The network interventions may include modifying an operational parameter of the RAN 110, changing a configuration of the RAN 110, introducing a new feature to the RAN 110, providing a software upgrade for the RAN 110, modifying an antenna angle, tilt, power, and/or the like of the RAN 110, modifying an operational parameter of the core network, changing a configuration of the core network, introducing a new feature to the core network, and/or the like. In some implementations, when merging the KPIs and the network interventions with the graphical NRM, the causal system 115 may attach the KPIs and the network interventions as features and associated links in the graphical NRM.

In some implementations, when merging the KPIs and the network interventions with the graphical NRM, the causal system 115 may attach the KPIs and the network interventions as features and associated links in the graphical NRM. For example, the KPIs and the network interventions may define the information in the feature vectors of the graphical NRM depicted in FIG. 1B. In some implementations, when generating the hypergraph NRM based on the graphical NRM, the KPIs, and the network interventions, the causal system 115 may define parameters for the hypergraph NRM (e.g., an order of the hypergraph NRM, such as a size of a vertex set, a size of the hypergraph NRM, such as a size of an edges set, and/or the like). The causal system 115 may represent clusters of the graphical NRM as hyperedges connecting multiple nodes and representing multilinear relationships, and may generate the hypergraph NRM based on the hyperedges and the multiple nodes.

The multilinear relationships may include higher-order interactions, every hyperedge may include an internal node of a tree or a directed acyclic graph, and vertices may include leaf nodes. The hypergraph NRM may represent cell group dynamics, rather than binary links. The hypergraph NRM may represent every relationship as a dyad, or pairwise interaction, and may enable representation of interactions between several cells. A hypergraph may include a generalization of a graph in which an edge can join any number of vertices. A hypergraph may represent a cluster (e.g., a group of cells) and may depict how multiple cells interact.

An example hypergraph NRM is depicted in FIG. 1C for a simple cellular cluster of two mid-band carriers (e.g., node M1 and node M2) and two millimeter wave carriers (e.g., node HS1 and node HS2) where cell group interactions are hyperedges (e.g., a first hyperedge e1 and a second hyperedge e2) represent an interface. The hyperedges may connect multiple nodes and may represent multi-way (or multilinear) relationships. In this example, the nodes V={M1, M2, HS1, HS2}, the hyperedges E={e1, e2}={({M1},{M2}), ({M1}, {HS1, HS2})}, and the hypergraph is a pair H=(V, E).

A hypergraph may be useful to represent clusters as hyperedges connecting multiple nodes and representing multilinear relationships (e.g., instead of a line representing a single link). This may enable the modeling of “higher-order interactions” between nodes. When modeling with just a graph, the modeling may only represent single link interactions. However, in real networks, a change in a cell may impact a neighboring cell and the neighboring cell may impact its neighbors as well. Another benefit is that the clusters can be defined dynamically. In conventional systems, a cluster is defined as a fixed quantity of nodes (e.g., a cluster can be a set of nodes across a path).

FIG. 1D depicts examples of higher order interactions in an example hypergraph. As shown, a hypergraph may include vertex embeddings that describe connectivity of each node and may be associated with first order inter-cell interference across links. The hypergraph may include path embeddings that describe traversal across the hypergraph and may be associated with higher order inter-cell interference across a path. The hypergraph may include graph embeddings that encode an entire hypergraph into a single vector and may be associated with higher order inter-cell interference across a cluster.

As shown in FIG. 1E, and by reference number 145, the causal system 115 may determine first embeddings that preserve a structure of the graphical NRM and second embeddings that preserve a structure of the hypergraph NRM. For example, when determining the first embeddings that preserve the structure of the graphical NRM, the causal system 115 may utilize a graph embedding technique to encode, based on local network neighborhoods, nodes of the graphical NRM into node vector embeddings that correspond to the first embeddings. In some implementations, when determining the second embeddings that preserve the structure of the hypergraph NRM, the causal system 115 may process the hypergraph NRM, with a simplicial neural network model, to generate the second embeddings.

The graph embedding technique may encode nodes into a latent vector space (e.g., may transform every node's properties into a vector with a smaller dimension). For example, the graph embedding technique may generate node vector embeddings based on local network neighborhoods using a graph neural network (GNN) layer that encodes information on the structure of the graphical NRM, where nodes aggregate messages from neighbor nodes using neural networks, a graph convolutional neural network averages neighborhood information, or a generalized neighborhood aggregation aggregates on a subset of the nodes. The first embeddings may include a representation of each node embedding with input features to a lower fixed-length dimensional vector of hidden features. An embedding is a low dimensional space into which a high dimensional space is translated (e.g., a way of mapping something complicated, such as an image, a graph, and/or the like, into something simple). An embedding may be a result of a neural network model learning what is important.

The causal system 110 may utilize simplicial neural networks (SNNs) or other types of neural networks to generate the second embeddings since SNNs use higher-order complexes to generalize the approach of GNNs to find high-order interactions. The second embeddings may include a representation of each node embedding with input features to a lower fixed-length dimensional vector of hidden features.

As shown in FIG. 1F, and by reference number 150, the causal system 115 may define a pre-intervention period and a post-intervention period and may train a causal impact model, based on the first embeddings, the second embeddings, the pre-intervention period, and the post-intervention period, to generate learned relationships. For example, the causal system 115 may define the pre-intervention period as a time period before one or more network interventions on the network, and may define the post-intervention period as a time after the one or more network interventions on the network.

In some implementations, the causal system 115 may divide the first embeddings, the second embeddings, the pre-intervention period, and the post-intervention period into a first portion of data, a second portion of data, and a third portion of data. The first portion, the second portion, and the third portion may include a same quantity of the first embeddings, the second embeddings, the pre-intervention period, and the post-intervention period, different quantities of the first embeddings, the second embeddings, the pre-intervention period, and the post-intervention period, and/or the like. In some implementations, more of the first embeddings, the second embeddings, the pre-intervention period, and the post-intervention period may be allotted to the first portion of data since the first portion may be utilized to generate the training data set for the causal impact model.

The causal system 115 may generate a training dataset for the causal impact model based on the first portion of data. The causal system 115 may generate a validation dataset for the causal impact model based on the second portion of data. The causal system 115 may generate a test dataset for the causal impact model based on the third portion of data. In other implementations, the causal system 115 may utilize different portions of the data to generate the training dataset, the validation dataset, and/or the test dataset for the causal impact model.

The causal system 115 may train the causal impact model with the training dataset to generate the learned relationships and a trained causal impact model. As described elsewhere herein, the causal impact model may be trained to process NRM data and a network intervention, and determine a causal effect of the network intervention. In some implementations, rather than training the causal impact model, the causal system 115 may obtain the trained causal impact model from another system or device that trained the causal impact model. In this case, the causal system 115 may provide the other system or device with the training dataset, the validation dataset, and/or the test dataset for use in training the causal impact model, and may provide the other system or device with updated training, validation, and/or test datasets to retrain the causal impact model in order to update the causal impact model.

In some implementations, the causal impact model may include a Rubin causal model or multiple causal impact models. A Rubin causal model is a model for generating causal inferences. A first part of the Rubin causal model is the use of potential outcomes to define causal effects in all situations. This part defines an object of inference and utilizes an explicit consideration of manipulations that define treatments and causal effects to estimate for the treatments. A second part of the Rubin causal model is an explicit probabilistic model for the assignment of the treatments to units as a function of all quantities that may be observed, including all potential outcomes. The probabilistic model is called an assignment mechanism and defines a structure of experiments designed to learn about the inference from observed data. A third optional part of the Rubin causal model is a distribution on quantities being conditioned on in the assignment mechanism, including potential outcomes, thereby allowing model-based Bayesian posterior predictive (e.g., causal) inference. This part of the Rubin causal model focuses on a model-based analysis of observed data to draw inferences for causal effects, where the observed data is revealed by applying the assignment mechanism to the inference.

In some implementations, the causal system 115 may train the causal impact model with the training dataset to generate the trained causal impact model, and may process the validation dataset, with the trained causal impact model, to validate that the trained causal impact model is operating correctly. If the trained causal impact model is operating correctly, the causal system 115 may process the trained causal impact model, with the test dataset, to further ensure that the trained causal impact model is operating correctly. A trained causal impact model can be said to be operating correctly if it has adequate accuracy, has adequate precision, has adequate recall, is not subject to excessive overfitting, and/or the like. If the trained causal impact model is operating excessively incorrectly (in contrast to known adequate levels), the causal system 115 may modify the trained causal impact model and may revalidate and/or retest the modified causal impact model based on the validation dataset and/or the test dataset.

In some implementations, when training the causal impact model, based on the first embeddings, the second embeddings, the pre-intervention period, and the post-intervention period, to generate the learned relationships, the causal system 115 may fit the causal impact model, with the first embeddings and the second embeddings and during the pre-intervention period, to determine relationships associated with interventions. The causal system 115 may apply the causal impact model, to the first embeddings and the second embeddings and during the post-intervention period, to determine impacts (e.g., causal effects) of the interventions, and may generate the learned relationships based on the relationships and the impacts. The learned relationships may include a determination of whether a network intervention had a statistically significant impact (e.g., causal effect on certain KPIs) on the network.

As further shown in FIG. 1F, and by reference number 155, the causal system 115 may retrain the causal impact model based on the learned relationships to generate a trained causal impact model. For example, the causal system 115 may update the training, validation, and/or test datasets based on the learned relationships to generate updated training, validation, and test datasets. The causal system 115 may retrain the causal impact model based on the updated training, validation, and/or test datasets in order to update the causal impact model (e.g., to generate the trained causal impact model).

As shown in FIG. 1G, and by reference number 160, the causal system 115 may perform one or more actions with the trained causal impact model. In some implementations, when performing the one or more actions, the causal system 115 processes an increase in power of a local cell, with the trained causal impact model, to determine a causal effect on a parent cell of the local cell. For example, the causal system 115 may process an increase in power of the RAN 110, with the trained causal impact model, to determine whether the power increase has a causal effect on a parent cell (e.g., a macro cell) of the RAN 110. If the power increase negatively impacts the parent cell, the causal system 115 may determine that the power of the RAN 110 should not be increased. In this way, the causal system 115 conserves computing resources, networking resources, and/or other resources that would otherwise have been consumed in failing to determine a causal impact of a network intervention on network performance.

In some implementations, when performing the one or more actions, the causal system 115 processes a configuration action on a cell, with the trained causal impact model, to determine a causal effect on neighboring cells of the cell. For example, the causal system 115 may process a configuration change for the RAN 110, with the trained causal impact model, to determine whether the configuration change has a causal effect on neighboring cells of the RAN 110. If the configuration change positively impacts the neighboring cells, the causal system 115 may determine that the configuration change should be implemented by the RAN 110. In this way, the causal system 115 conserves computing resources, networking resources, and/or other resources that would otherwise have been consumed in performing a network intervention without knowing the causal impact of the network intervention.

In some implementations, when performing the one or more actions, the causal system 115 processes a feature introduction on a cell (e.g. introducing 3-channel carrier aggregation, uplink coverage boosting or the like), with the trained causal impact model, to determine a causal effect of a performance improvement for the cell. For example, the causal system 115 may process a feature introduction for the RAN 110, with the trained causal impact model, to determine whether the feature introduction has a causal effect of a performance improvement for the RAN 110. If the feature introduction does not improve the performance of the RAN 110, the causal system 115 may determine that the feature should not be introduced for the RAN 110 (e.g., the causal system 115 may output a binary response, a confidence interval, and/or the like). In this way, the causal system 115 conserves computing resources, networking resources, and/or other resources that would otherwise have been consumed in rendering a network device or a portion of a network inoperable based on performing the network intervention.

In some implementations, when performing the one or more actions, the causal system 115 processes a software upgrade on a RAN, with the trained causal impact model, to determine a causal effect of a performance improvement for the RAN. For example, the causal system 115 may process a software upgrade on the RAN 110, with the trained causal impact model, to determine whether the software upgrade has a causal effect of a performance improvement for the RAN 110. If the software upgrade does not improve the performance of the RAN 110, the causal system 115 may determine that the software upgrade should not be implemented in the RAN 110. In this way, the causal system 115 conserves computing resources, networking resources, and/or other resources that would otherwise have been consumed in failing to determine a causal impact of a network intervention on network performance.

In some implementations, when performing the one or more actions, the causal system 115 processes an intervention of one of the first embeddings or the second embeddings, with the trained causal impact model, to determine a causal effect of the intervention. For example, the causal system 115 may process a network intervention for the RAN 110, with the trained causal impact model, to determine whether the network intervention has a causal effect on the RAN 110. If the network intervention positively impacts the RAN 110, the causal system 115 may determine that the network intervention should be implemented. In this way, the causal system 115 conserves computing resources, networking resources, and/or other resources that would otherwise have been consumed in performing a network intervention without knowing the causal impact of the network intervention.

In some implementations, when performing the one or more actions, the causal system 115 stores the causal effects in a causal patterns data structure. For example, the causal system 115 may store the causal effects (e.g., the causal effect on the parent cell of the local cell, the causal effect on the neighboring cells of the cell, the causal effect of the performance improvement for the cell, the causal effect of the performance improvement for the RAN, the causal effect of the intervention, and/or the like) determined by the causal impact model in a data structure (e.g., a database, a table, a list, and/or the like) associated with the causal system 115, the RAN 110, and/or the core network. The RAN 110 and/or the core network may utilize the data structure to determine causal effects of proposed network interventions in real time. In this way, the causal system 115 may conserve computing resources, networking resources, and/or other resources that would otherwise have been consumed in failing to determine a causal impact of a network intervention on network performance, performing a network intervention without knowing the causal impact of the network intervention, rendering a network device or a portion of a network under-performing or inoperable based on performing the network intervention, and/or the like.

In some implementations, when performing the one or more actions, the causal system 115 retrains the causal impact model based on the causal effects (e.g., the causal effect on the parent cell of the local cell, the causal effect on the neighboring cells of the cell, the causal effect of the performance improvement for the cell, the causal effect of the performance improvement for the RAN, the causal effect of the intervention, and/or the like). For example, the causal system 115 may utilize the causal effects as additional training data for retraining the causal impact model, thereby increasing the quantity of training data available for training the causal impact model. Accordingly, the causal system 115 may conserve computing resources associated with identifying, obtaining, and/or generating historical data for training the causal impact model, relative to other systems for identifying, obtaining, and/or generating historical data for training machine learning models.

In this way, the causal system 115 provides a unified causal impact model with hyperedge-enhanced embedding for network interventions. For example, the causal system 115 may provide a causal impact model that represents cause-effect connections in networks and that determines an effectiveness of network interventions in an objective and quantitative way. The causal system 115 may utilize the causal impact model and hypergraph neural networks to improve learning representation and explainability of network performance. The hypergraph may help explainability since the hypergraph provides a fine-grained view of all possible explanations for what is occurring in the network. For example, the hypergraph may aid in explaining an impact of an intervention in terms of higher order interactions and not only binary interactions.

The causal system 115 may perform knowledge engineering of the network to generate a hypergraph that captures each network node and relationships of the network node with neighboring network nodes. Thus, the causal system 115 may conserve computing resources, networking resources, and/or other resources that would otherwise have been consumed in failing to determine a causal impact of a network intervention on network performance, performing a network intervention without knowing the causal impact of the network intervention, rendering a network device or a portion of a network under-performing or inoperable based on performing the network intervention, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

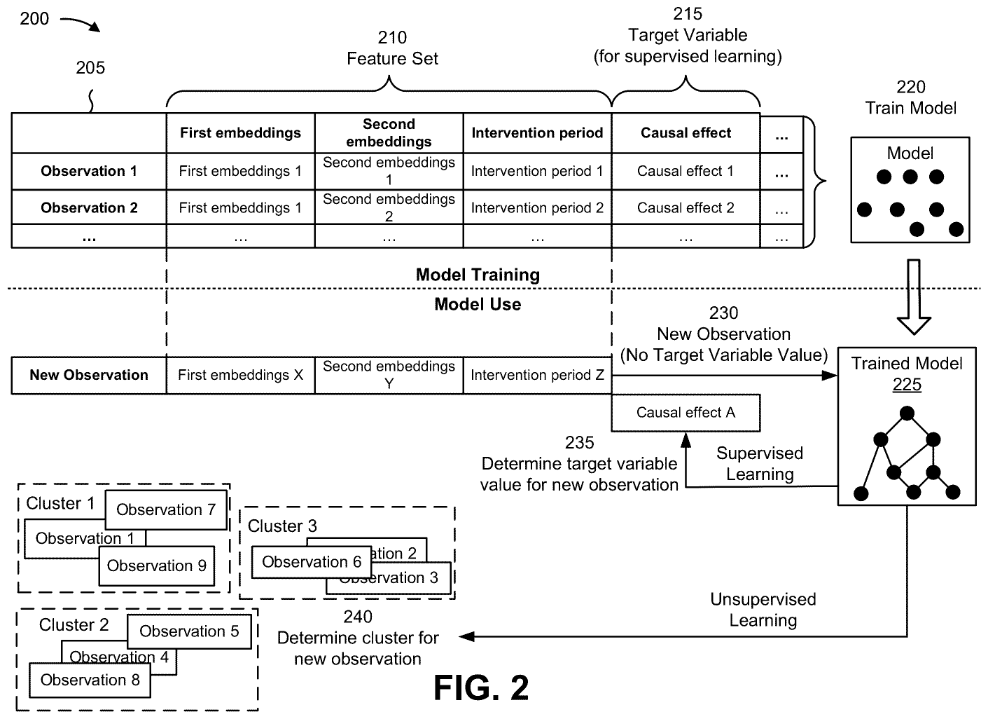

FIG. 2 is a diagram illustrating an example 200 of training and using a machine learning model for determining a causal impact of a network intervention. The machine learning model training and usage described herein may be performed using a machine learning system. The machine learning system may include or may be included in a computing device, a server, a cloud computing environment, and/or the like, such as the causal system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the causal system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the causal system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of first embeddings, a second feature of second embeddings, a third feature of an intervention period, and so on. As shown, for a first observation, the first feature may have a value of first embeddings 1, the second feature may have a value of second embeddings 1, the third feature may have a value of intervention period 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be labelled “causal effect” and may include a value of causal effect 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of first embeddings X, a second feature of second embeddings Y, a third feature of intervention period Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of causal effect A for the target variable of the causal effect for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first embeddings cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second embeddings cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to determine a causal impact of a network intervention. The machine learning system enables recognition and/or identification of tens, hundreds, thousands, or millions of features and/or feature values for tens, hundreds, thousands, or millions of observations, thereby increasing accuracy and consistency and reducing delay associated with determining a causal impact of a network intervention relative to requiring computing resources to be allocated for tens, hundreds, or thousands of operators to manually determine a causal impact of a network intervention.

As indicated above, FIG. 2 is provided as an example. Other examples may differ from what is described in connection with FIG. 2.

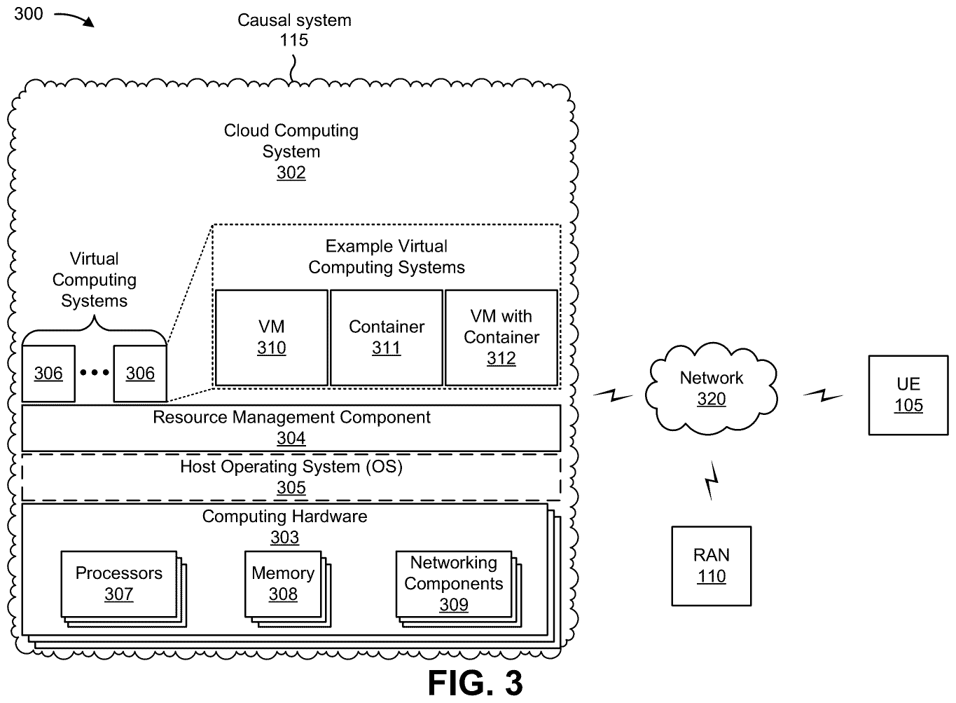

FIG. 3 is a diagram of an example environment 300 in which systems and/or methods described herein may be implemented. As shown in FIG. 3, the environment 300 may include the causal system 115, which may include one or more elements of and/or may execute within a cloud computing system 302. The cloud computing system 302 may include one or more elements 303-312, as described in more detail below. As further shown in FIG. 3, the environment 300 may include the UE 105, the RAN 110, and/or a network 320. Devices and/or elements of the environment 300 may interconnect via wired connections and/or wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 110 may support, for example, a cellular radio access technology (RAT). The RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The RAN 110 may transfer traffic between the UE 105 (e.g., using a cellular RAT), one or more base stations (e.g., using a wireless interface or a backhaul interface, such as a wired backhaul interface), and/or a core network. The RAN 110 may provide one or more cells that cover geographic areas.

In some implementations, the RAN 110 may perform scheduling and/or resource management for the UE 105 covered by the RAN 110 (e.g., the UE 105 covered by a cell provided by the RAN 110). In some implementations, the RAN 110 may be controlled or coordinated by a network controller, which may perform load balancing, network-level configuration, and/or other operations. The network controller may communicate with the RAN 110 via a wireless or wireline backhaul. In some implementations, the RAN 110 may include a network controller, a self-organizing network (SON) module or component, or a similar module or component. In other words, the RAN 110 may perform network control, scheduling, and/or network management functions (e.g., for uplink, downlink, and/or sidelink communications of the UE 105 covered by the RAN 110).

In some aspects, the term “RAN” (e.g., the RAN 110) or “network node” or “network entity” may refer to an aggregated base station, a disaggregated base station, an integrated access and backhaul (IAB) node, a relay node, and/or one or more components thereof. For example, in some aspects, “RAN,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “RAN,” “network node,” or “network entity” may refer to one device configured to perform one or more functions, such as those described herein in connection with the RAN 110. In some aspects, the term “RAN,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “RAN,” “network node,” or “network entity” may refer to any one or more of those different devices. In some aspects, the term “RAN,” “network node,” or “network entity” may refer to one or more virtual base stations and/or one or more virtual base station functions. For example, in some aspects, two or more base station functions may be instantiated on a single device. In some aspects, the term “RAN,” “network node,” or “network entity” may refer to one of the base station functions and not another. In this way, a single device may include more than one base station.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, and/or one or more networking components 309. Examples of a processor, a memory, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 includes a virtual environment that enables cloud-based execution of operations and/or processes described herein using the computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

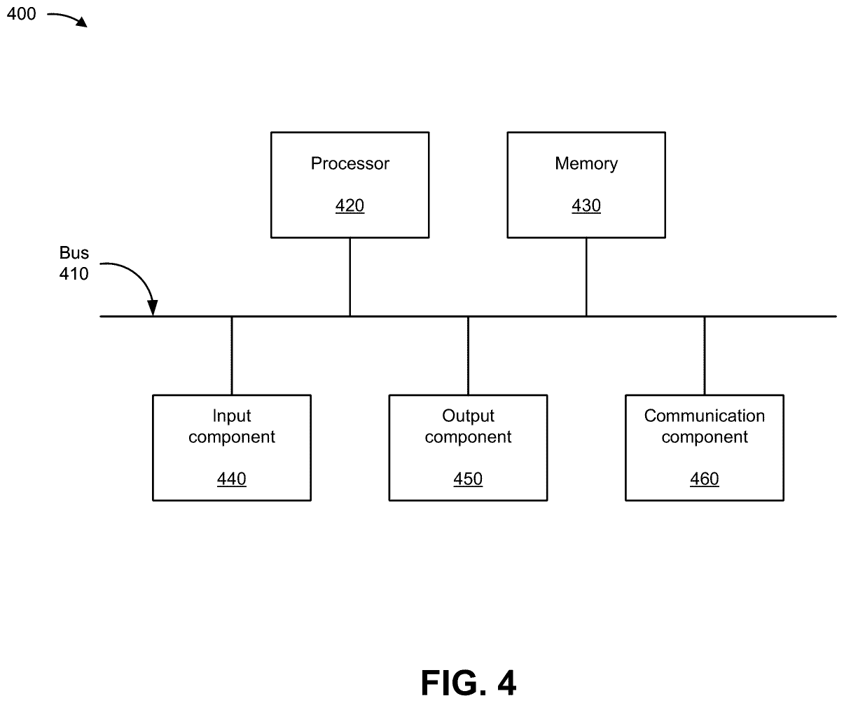

Although the causal system 115 may include one or more elements 303-312 of the cloud computing system 302, may execute within the cloud computing system 302, and/or may be hosted within the cloud computing system 302, in some implementations, the causal system 115 may not be cloud-based (e.g., may be implemented outside of a cloud computing system) or may be partially cloud-based. For example, the causal system 115 may include one or more devices that are not part of the cloud computing system 302, such as a device 400 of FIG. 4, which may include a standalone server or another type of computing device. The causal system 115 may perform one or more operations and/or processes described in more detail elsewhere herein.

The network 320 may include one or more wired and/or wireless networks. For example, the network 320 may include a cellular network (e.g., a 5G network, a 4G network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the UE 105, the RAN 110, and/or the causal system 115. In some implementations, the UE 105, the RAN 110, and/or the causal system 115 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. Memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

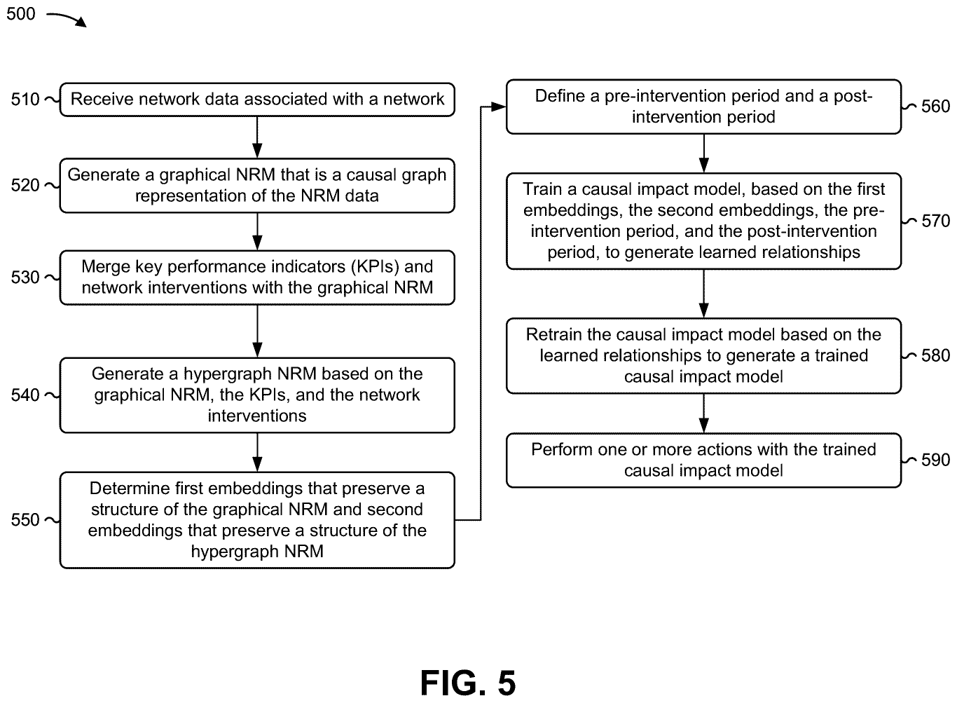

FIG. 5 is a flowchart of an example process 500 for providing a unified causal impact model with hyperedge-enhanced embedding for network interventions. In some implementations, one or more process blocks of FIG. 5 may be performed by a device (e.g., the causal system 115). In some implementations, one or more process blocks of FIG. 5 may be performed by another device or a group of devices separate from or including the device, such as a UE (e.g., the UE 105) and/or a RAN (e.g., the RAN 110). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving network data associated with a network (block 510). For example, the device may receive network data that includes NRM data identifying application layer data, user related data, network layer data, and physical layer data associated with a network that includes a plurality of UEs, a plurality of RANs, and a core network, as described above.

As further shown in FIG. 5, process 500 may include generating a graphical NRM that is a causal graph representation of the NRM data (block 520). For example, the device may generate a graphical NRM that is a causal graph representation of the NRM data, as described above. In some implementations, generating the graphical NRM includes determining a structure of the network based on the NRM data, generating a topology of the network based on the structure, generating services of the network based on the structure, and generating the graphical NRM based on the topology and the services.

As further shown in FIG. 5, process 500 may include merging KPIs and network interventions with the graphical NRM (block 530). For example, the device may merge KPIs and network interventions with the graphical NRM, as described above. In some implementations, merging the KPIs and the network interventions with the graphical NRM includes attaching the KPIs and the network interventions as features and associated links in the graphical NRM.

As further shown in FIG. 5, process 500 may include generating a hypergraph NRM based on the graphical NRM, the KPIs, and the network interventions (block 540). For example, the device may generate a hypergraph NRM based on the graphical NRM, the KPIs, and the network interventions, as described above. In some implementations, generating the hypergraph NRM based on the graphical NRM, the KPIs, and the network interventions includes representing clusters of the graphical NRM as hyperedges connecting multiple nodes and representing multilinear relationships, and generating the hypergraph NRM based on the hyperedges and the multiple nodes.

As further shown in FIG. 5, process 500 may include determining first embeddings that preserve a structure of the graphical NRM and second embeddings that preserve a structure of the hypergraph NRM (block 550). For example, the device may determine first embeddings that preserve a structure of the graphical NRM and second embeddings that preserve a structure of the hypergraph NRM, as described above. In some implementations, determining the first embeddings that preserve the structure of the graphical NRM includes utilizing a graph embedding technique to encode, based on local network neighborhoods, nodes of the graphical NRM into node vector embeddings that correspond to the first embeddings. In some implementations, determining the second embeddings that preserve the structure of the hypergraph NRM includes processing the hypergraph NRM, with a simplicial neural network model, to generate the second embeddings.

As further shown in FIG. 5, process 500 may include defining a pre-intervention period and a post-intervention period (block 560). For example, the device may define a pre-intervention period and a post-intervention period, as described above.

As further shown in FIG. 5, process 500 may include training a causal impact model, based on the first embeddings, the second embeddings, the pre-intervention period, and the post-intervention period, to generate learned relationships (block 570). For example, the device may train a causal impact model, based on the first embeddings, the second embeddings, the pre-intervention period, and the post-intervention period, to generate learned relationships, as described above. In some implementations, training the causal impact model, based on the first embeddings, the second embeddings, the pre-intervention period, and the post-intervention period, to generate the learned relationships includes fitting the causal impact model, with the first embeddings and the second embeddings and during the pre-intervention period, to determine relationships associated with interventions; applying the causal impact model, to the first embeddings and the second embeddings and during the post-intervention period, to determine impacts of the interventions; and generating the learned relationships based on the relationships and the impacts. In some implementations, the causal impact model is a Rubin causal impact model.

As further shown in FIG. 5, process 500 may include retraining the causal impact model based on the learned relationships to generate a trained causal impact model (block 580). For example, the device may retrain the causal impact model based on the learned relationships to generate a trained causal impact model, as described above.

As further shown in FIG. 5, process 500 may include performing one or more actions with the trained causal impact model (block 590). For example, the device may perform one or more actions with the trained causal impact model, as described above. In some implementations, performing the one or more actions includes one or more of processing an increase in power of a local cell, with the trained causal impact model, to determine a causal effect on a parent cell of the local cell; processing a configuration action on a cell, with the trained causal impact model, to determine a causal effect on neighboring cells of the cell; or processing a feature introduction on a cell, with the trained causal impact model, to determine a causal effect of a performance improvement for the cell.

In some implementations, performing the one or more actions includes one or more of processing a software upgrade on a RAN, with the trained causal impact model, to determine a causal effect of a performance improvement for the RAN; or processing an intervention of one of the first embeddings or the second embeddings, with the trained causal impact model, to determine a causal effect of the intervention. In some implementations, performing the one or more actions includes processing a plurality of interventions for the network, with the trained causal impact model, to determine a corresponding plurality of causal effects of the plurality of interventions, and storing the plurality of causal effects in a data structure.

In some implementations, performing the one or more actions includes processing a plurality of interventions for the network, with the trained causal impact model, to determine a corresponding plurality of causal effects of the plurality of interventions, and retraining the causal impact model based on the plurality of causal effects. In some implementations, performing the one or more actions includes implementing the trained causal impact model in the network.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, network resource model (NRM) data identifying application layer data, user related data, network layer data, and physical layer data associated with a network that includes a plurality of user equipment, a plurality of radio access networks, and a core network;
generating, by the device, a graphical NRM that is a causal graph representation of the NRM data;
merging, by the device, key performance indicators (KPIs) and network interventions with the graphical NRM;
generating, by the device, a hypergraph NRM based on the graphical NRM, the KPIs, and the network interventions;
determining, by the device, first embeddings that preserve a structure of the graphical NRM and second embeddings that preserve a structure of the hypergraph NRM;
defining, by the device, a pre-intervention period and a post-intervention period;
training, by the device, a causal impact model, based on the first embeddings, the second embeddings, the pre-intervention period, and the post-intervention period, to generate learned relationships;
retraining, by the device, the causal impact model based on the learned relationships to generate a trained causal impact model; and
performing, by the device, one or more actions with the trained causal impact model.

2. The method of claim 1, wherein generating the graphical NRM comprises:
determining a structure of the network based on the NRM data;
generating a topology of the network based on the structure;
generating services of the network based on the structure; and
generating the graphical NRM based on the topology and the services.

3. The method of claim 1, wherein merging the KPIs and the network interventions with the graphical NRM comprises:
attaching the KPIs and the network interventions as features and associated links in the graphical NRM.

4. The method of claim 1, wherein generating the hypergraph NRM based on the graphical NRM, the KPIs, and the network interventions comprises:
representing clusters of the graphical NRM as hyperedges connecting multiple nodes and representing multilinear relationships; and
generating the hypergraph NRM based on the hyperedges and the multiple nodes.

5. The method of claim 1, wherein determining the first embeddings that preserve the structure of the graphical NRM comprises:
utilizing a graph embedding technique to encode, based on local network neighborhoods, nodes of the graphical NRM into node vector embeddings that correspond to the first embeddings.

6. The method of claim 1, wherein determining the second embeddings that preserve the structure of the hypergraph NRM comprises:
processing the hypergraph NRM, with a simplicial neural network model, to generate the second embeddings.

7. The method of claim 1, wherein training the causal impact model, based on the first embeddings, the second embeddings, the pre-intervention period, and the post-intervention period, to generate the learned relationships comprises:
fitting the causal impact model, with the first embeddings and the second embeddings and during the pre-intervention period, to determine relationships associated with interventions;
applying the causal impact model, to the first embeddings and the second embeddings and during the post-intervention period, to determine impacts of the interventions; and
generating the learned relationships based on the relationships and the impacts.

8. A device, comprising:
one or more processors configured to:
receive network resource model (NRM) data identifying application layer data, user related data, network layer data, and physical layer data associated with a network that includes a plurality of user equipment, a plurality of radio access networks, and a core network;
determine a structure of the network based on the NRM data;
generate a topology of the network based on the structure;
generate services of the network based on the structure;
generate a graphical NRM based on the topology and the services;
merge key performance indicators (KPIs) and network interventions with the graphical NRM;
generate a hypergraph NRM based on the graphical NRM, the KPIs, and the network interventions;
determine first embeddings that preserve a structure of the graphical NRM and second embeddings that preserve a structure of the hypergraph NRM;
define a pre-intervention period and a post-intervention period;
train a causal impact model, based on the first embeddings, the second embeddings, the pre-intervention period, and the post-intervention period, to generate learned relationships;
retrain the causal impact model based on the learned relationships to generate a trained causal impact model; and
perform one or more actions with the trained causal impact model.

9. The device of claim 8, wherein the causal impact model is a Rubin causal impact model.

10. The device of claim 8, wherein the one or more processors, to perform the one or more actions, are configured to one or more of:
process an increase in power of a local cell, with the trained causal impact model, to determine a causal effect on a parent cell of the local cell;
process a configuration action on a cell, with the trained causal impact model, to determine a causal effect on neighboring cells of the cell; or
process a feature introduction on a cell, with the trained causal impact model, to determine a causal effect of a performance improvement for the cell.

11. The device of claim 8, wherein the one or more processors, to perform the one or more actions, are configured to one or more of:
process a software upgrade on a radio access network, with the trained causal impact model, to determine a causal effect of a performance improvement for the radio access network; or
process an intervention of one of the first embeddings or the second embeddings, with the trained causal impact model, to determine a causal effect of the intervention.

12. The device of claim 8, wherein the one or more processors, to perform the one or more actions, are configured to:
process a plurality of interventions for the network, with the trained causal impact model, to determine a corresponding plurality of causal effects of the plurality of interventions; and
store the plurality of causal effects in a data structure.

13. The device of claim 8, wherein the one or more processors, to perform the one or more actions, are configured to:
process a plurality of interventions for the network, with the trained causal impact model, to determine a corresponding plurality of causal effects of the plurality of interventions; and
retrain the causal impact model based on the plurality of causal effects.

14. The device of claim 8, wherein the one or more processors, to perform the one or more actions, are configured to:
implement the trained causal impact model in the network.

15. A non-transitory computer-readable medium storing a set of instructions, the set of instructions comprising:
one or more instructions that, when executed by one or more processors of a device, cause the device to:
receive network resource model (NRM) data identifying application layer data, user related data, network layer data, and physical layer data associated with a network that includes a plurality of user equipment, a plurality of radio access networks, and a core network;
generate a graphical NRM that is a causal graph representation of the NRM data;
attach key performance indicators (KPIs) and network interventions as features and associated links in the graphical NRM;
generate a hypergraph NRM based on the graphical NRM, the KPIs, and the network interventions;
determine first embeddings that preserve a structure of the graphical NRM and second embeddings that preserve a structure of the hypergraph NRM;
define a pre-intervention period and a post-intervention period;
train a causal impact model, based on the first embeddings, the second embeddings, the pre-intervention period, and the post-intervention period, to generate learned relationships;
retrain the causal impact model based on the learned relationships to generate a trained causal impact model; and
perform one or more actions with the trained causal impact model.

16. The non-transitory computer-readable medium of claim 15, wherein the one or more instructions, that cause the device to generate the graphical NRM, cause the device to:
determine a structure of the network based on the NRM data;
generate a topology of the network based on the structure;
generate services of the network based on the structure; and
generate the graphical NRM based on the topology and the services.

17. The non-transitory computer-readable medium of claim 15, wherein the one or more instructions, that cause the device to generate the hypergraph NRM based on the graphical NRM, the KPIs, and the network interventions, cause the device to:
represent clusters of the graphical NRM as hyperedges connecting multiple nodes and representing multilinear relationships; and
generate the hypergraph NRM based on the hyperedges and the multiple nodes.

18. The non-transitory computer-readable medium of claim 15, wherein the one or more instructions, that cause the device to determine the first embeddings that preserve the structure of the graphical NRM, cause the device to:
utilize a graph embedding technique to encode, based on local network neighborhoods, nodes of the graphical NRM into node vector embeddings that correspond to the first embeddings.

19. The non-transitory computer-readable medium of claim 15, wherein the one or more instructions, that cause the device to determine the second embeddings that preserve the structure of the hypergraph NRM, cause the device to:
process the hypergraph NRM, with a simplicial neural network model, to generate the second embeddings.

20. The non-transitory computer-readable medium of claim 15, wherein the one or more instructions, that cause the device to train the causal impact model, based on the first embeddings, the second embeddings, the pre-intervention period, and the post-intervention period, to generate the learned relationships, cause the device to:
fit the causal impact model, with the first embeddings and the second embeddings and during the pre-intervention period, to determine relationships associated with interventions;
apply the causal impact model, to the first embeddings and the second embeddings and during the post-intervention period, to determine impacts of the interventions; and
generate the learned relationships based on the relationships and the impacts.
